(19) United States
(12) Patent Application Publication
(10) Pub. No.: US 2007/0168345 A1
(43) Pub. Date: Jul. 19, 2007

(54) SYSTEM AND METHOD OF IDENTIFYING SUBJECT MATTER EXPERTS

(76) Inventors: Andrew Gibbs, Yuba City, CA (US); Stephanie Gibbs, Yuba City, CA (US)

Correspondence Address: MAIER & MAIER, PLLC, 1000 DUKE STREET, ALEXANDRIA, VA, 22314, US

(21) Appl. No.: 11/624,051

(22) Filed: Jan. 17, 2007

Related U.S. Application Data
(60) Provisional application No. 60/759,009, filed on Jan. 17, 2006.

(51) Int. Cl. G06F 17/30

(52) U.S. Cl. 707/5

(57) ABSTRACT

A method and system for searching a data collection to identify employee candidates using the text of job description as a semantic search query upon a database containing patent literature or non-patent literature. An exemplary embodiment discloses employee candidates for the described job in a relevancy-ranked order based on the proximity of the search results to the latent semantic analysis search query.

### PRIORITY

This application claims priority under 35 U.S.C. 119(e) to U.S. Provisional Application No. 60/759,009, filed Jan. 17, 2006, the content of which is hereby incorporated by reference in its entirety.

### FIELD

At least one exemplary embodiment of the present invention is generally related to the field of recruiting. More particularly, it is directed to a system and method of identifying qualified employee candidates.

### BACKGROUND

Recruiting employee candidates is an age-old and well-known practice among employers and professional employment recruiters.

There are a number of methods used to locate potential employees, including the placement of a classified advertisement in the employment section of a newspaper, or upon a website such as Monster.com. In such cases, the employer is hoping that the candidate is seeking employment, and that the prospective employee will read the job description at the precise time the posting or classified ad is available. The advertisements are generally placed at a very low cost compared to the salary that they will be offering to the candidate. At best, it is serendipitous if the employer's advertisement and the best employee candidate converge at the same time. Typically, individuals who are not seeking employment would be better employee candidates than those reading the advertisements. However, they are difficult to identify, qualify and it is difficult to communicate with them openly.

Since employers understand the inefficiencies of posting or placing employment advertisements, they often times hire professional employee recruiters to seek out and identify the best candidates for a particular job opening. Recruiters may charge the employer a fee equal to half of the first year's salary that would be paid to the employee ultimately hired. Needless to say, this form of recruiting is expensive and is typically reserved for trying to find highly experienced candidates in a competitive job market.

The first method of recruiting, namely, placing job opening advertisements in newspapers or on websites, is low cost, but inefficient. Conversely, the second method of recruiting, namely the hiring of an employment recruiter, is efficient but high cost.

The following patent publications illustrate and describe various background system and/or methods for data mining. US 20030036924 teaches a system for identifying a clinician's specialty by examining procedures performed by the clinician, the diagnoses made by the clinician, and the age and gender of the clinician's patients. US 20020055870 teaches an automated human resource assessment system having computer-based processes. Specifically, programmable hardware or software system having standardized profile parameters. US 20030149613 teaches a computer-implemented method and system for assessing performance-related data. US 20030130871 teaches a system and method for selecting prospective patients for a clinical trial. In various embodiments, a clinical trials brokerage appears configured to receive requests from drug companies for lists of persons meeting specific rules. US 20020143789 teaches a computer-based automated planning method utilizing a record for an individual containing achievements obtained from one or more sources. Each achievement appears to be translated into a course equivalent for each institution. U.S. Pat. No. 5,721,910 teaches an automated method of classifying technological publications and abstracts into various business, scientific or technical fields. It appears to require specific technical categories into which the technical publications will be assigned.

### SUMMARY

In at least one embodiment, a system for identifying subject matter experts is disclosed. The system may include a first database populated by a first data collection having a plurality of bibliographic text data and may include a second database that is a semantic database. The second database may be populated by a plurality of pseudo-vectors for expressing the plurality of semantic concepts found in the first data collection. A search module having search parameters may further be included in the system. The search module can be interfaced with either or both the first database and the second database. Further, the search module may be configured to perform a semantic search query and may be configured to return a relevancy-ranked search result set identifying subject matter experts.

In at least one other embodiment, a method of identifying subject matter experts is disclosed. The method may include submitting a search query to a semantic database populated by a plurality of pseudo-vectors expressing a plurality of concepts from a data collection such as a structured database. The method may also include applying the submitted search query to a semantic database. The method may return a result set from the data collection. The result set may contain data identifying subject matter expert candidates in relevancy-ranked order.

In at least one preferred embodiment, the first data collection includes patent literature (e.g., granted patents and published patent applications). Also, the subject matter experts identified may be patent professionals.

### BRIEF DESCRIPTION OF THE DRAWINGS

For a more complete understanding of the exemplary embodiments of the present invention and the advantages thereof, reference is now made to the following descriptions taken in conjunction with the accompanying drawings, wherein:

FIG. 1. shows a flow chart of an exemplary embodiment of a process for submitting a semantic search query having the text of a job description and applying it to a patent database.

FIG. 2. shows a flow chart of an exemplary embodiment of a process for developing inferred qualifications of the candidates as determined by applying a set of rules to each qualification and recording the inferred qualifications in a new table.

FIG. 3. shows a flow chart of an exemplary embodiment of the addition of databases that would be used to determine possible relocation expenses for the candidates if hired and a salary comparison database.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

One embodiment can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus or device.

The medium can be electronic, magnetic, optical, electromagnetic, infrared, or semiconductor system (or apparatus or device) or a propagation medium. Nonlimiting examples of a computer-readable medium include a semiconductor or solid state memory, magnetic tape, a removable computer diskette, a random access memory (RAM), a read-only memory (ROM), a rigid magnetic disk and optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to rescue the number of times code must be retrieved from bulk storage execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

Further, exemplary embodiments include or incorporate at least one database which may store software, descriptive data, system data, digital images and any other data item required by the other components necessary to effectuate any embodiment of the present system and method known to one having ordinary skill in the art. The databases may be provided, for example, as a database management system (DBMS), a relational database management system (e.g., DB2, ACCESS, etc.), an object-oriented database management system (ODBMS), a file system or another conventional database package as a few non-limiting examples. The databases can be accessed via a Structure Query Language (SQL) or other tools known to one having skill in the art.

At least one embodiment herein may be implemented via a distributed computing environment, such as the Internet, where tasks are performed by remote processing devices that are linked through a communications network. Those skilled in the art will also appreciate that other communications systems can be used, such as direct dial communication over public or private telephone lines, a dedicated wide area network, or the like. In the distributed computing environment, computer-executable instructions and program modules for performing the features of embodiments may be located in both local and remote storage devices.

In at least one embodiment, the system and method of identifying candidates for positions may include at least a database of pseudo resumes, a latent semantic analysis database containing the concepts expressed in the pseudo resumes, and a means of extracting the names from the documents most closely related to the employee skills inferred from the full text of the job description used as the search query upon the semantic database.

The search results may contain a list of potential employees meeting the requirements of the job description, along with any other requirements that may alter the initial search results list. The results list can show the most qualified candidates toward the top of the list, but thereafter the searcher may sort the list based on different criteria such as proximity between the address of record for the employee and the location of a hiring organization.

At least one exemplary embodiment of the present invention discloses the searching of patent data to identify technical or otherwise qualified subject matter experts (such as engineers, scientists and executives), or patent professionals including patent examiners and patent attorneys/agents using the full text of the job description as a latent semantic search query. Thus, in at least one exemplary embodiment, the database of patent documents is used as a pseudo-resume database.

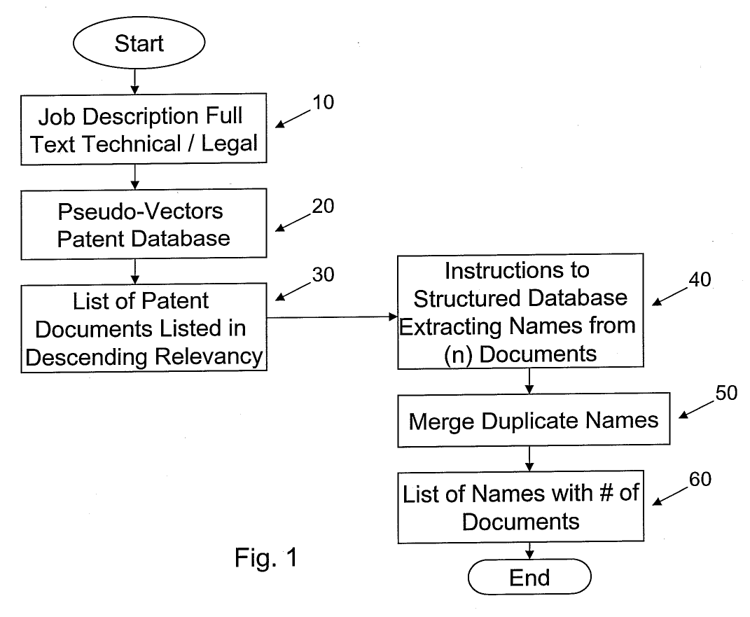

A flowchart showing one exemplary embodiment of the present invention is shown in FIG. 1. A job description 10 may be used as a search query applied to a semantic database 20 containing the concepts expressed in the patent literature. The results set 30 from the search may contain a list of patent documents organized with the most relevant documents listed first, declining in relevancy thereafter. In order to identify the candidates for the described job, the names listed on the results set 30 may be extracted from a structured database 40. If the job recruiter is seeking a technical person or otherwise qualified inventor, the names may be extracted from the “Inventor Name” field of the patent documents. If the recruiter is seeking a patent legal professional, the names may be extracted from the “Attorney/Agent” data field of the patent documents. Optionally, the incorporation of law firm names (such as Fish & Richardson, Sughrue Mion, and Oblon Spivak McClelland Maier & Neustadt, etc.) in the “Attorney/Agent” data field may be ignored and only attorneys or agents named, if any, in the data field may be extracted. Likewise, if the recruiter is seeking a patent examiner, the names may be extracted from the “Examiner” data field. The extracted names may optionally be checked for duplicates and merged 50. A list of names 60 may be generated that, optionally, can show the total number of documents associated with each name. The final list 60 can optionally be sorted by the recruiter, or programmatically, so that the names associated with the most relevant patent documents from the results list 30 are displayed first, or so that the names with the most associated documents shown in the final list 60 may be displayed first.

In addition to identifying potential candidates in the final list 60 based on the relevancy of the pseudo-resumes 30 to the job description search query 10, a set of additional rules may be applied that can infer at least a candidate's qualifications for the particular job opportunity, including but not limited to number of job-hops, knowledge inventory, years of experience in the field, and team player verses solo worker characterization.

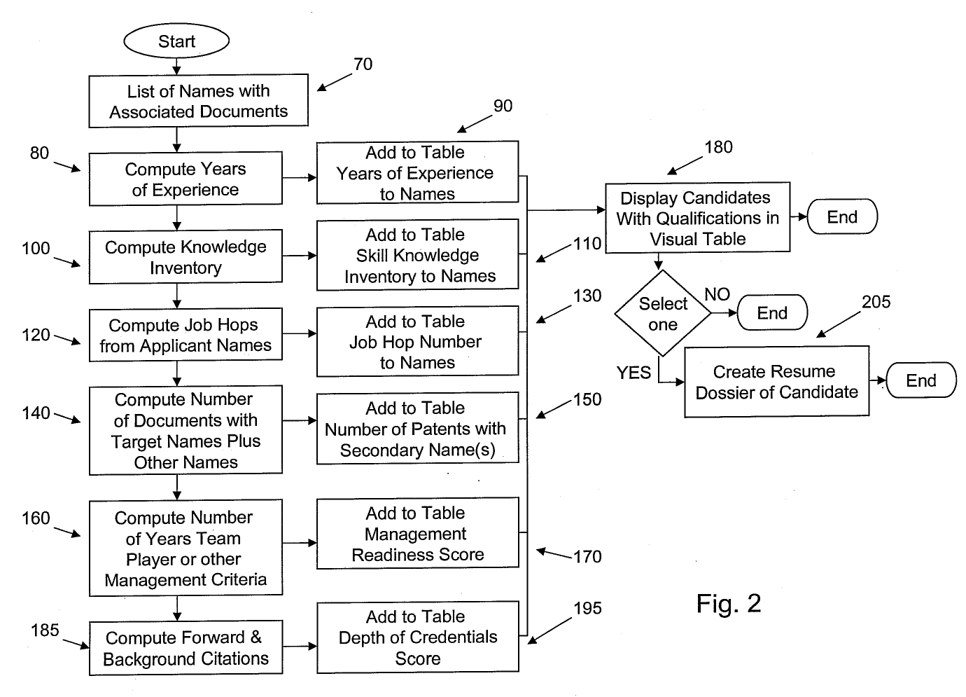

Referring now to the exemplary embodiment shown in the flowchart of FIG. 2, after compiling the list of names 70 (i.e. final list 60 from FIG. 1) related to the patent documents most relevant to the search query, a set of additional inference filters can be applied to obtain a more acute understanding of the skills and aptitudes of the candidates. This may be accomplished by applying a set of rules to create inferred qualifications in areas of interest to prospective employers. There may not be a particular order of applying the inference filters, and the filters 80, 100, 120, 140, 160 and 185 are not meant to be exhaustive. In the first inference filter 80 the years of experience of each candidate may be computed by subtracting the date of the earliest document containing the name of a person from the date of the most recent document containing the same name. The list of names, along with the number of inferred years of experience may optionally be recorded in a separate table 90 for immediate or later use by a recruiter.

A next inference filter 100 assesses the knowledge inventory of each listed name. This inference may be computed by analyzing and recording the total number of different patent classifications contained on all documents associated with each name on the results list 70. The patent classifications, the definition of the patent classifications, or a concordance of the patent classifications to a list of skill sets may optionally be recorded in a separate table 110 for immediate or later use by a recruiter.

A next inference filter 120 establishes the inferred employment stability (e.g., by way of job hops) of each candidate on the list of names 70. This may be computed by identifying the total number of different applicants listed on all patent documents containing the candidate's name. The number of applicants and candidate names may optionally be recorded in a separate table 130 for immediate or later use by a recruiter.

It should be said that the computational assessment of this or other inferred filters shown are not intended to be limiting and embodiments may contain additional processes or algorithms that, for example, take into account a combination of inferred qualifications to develop a better picture of the candidate's qualifications. For instance, the total inferred years experience divided by the number of applicant names provide a total inferred average number of years between job hops of each candidate, a better picture of employment stability than the total number of job hops alone. Likewise, other systems, methods and algorithms known to one having ordinary skill in the art that help develop a better picture of the candidate's qualifications may be used.

Still referring to FIG. 2, a next filter 140 assesses the likelihood that a candidate can be a team player by computing the number of patent documents that contain the name of the candidate in addition to one or more associated names. In the case of inventors, the additional names could be co-inventors. The more patents or published applications that may contain the target candidate's name along with a larger number of co-inventors, the more likely the candidate may be a good performer or be otherwise desirable in a development team environment. The inferred team player score with each name may optionally be recorded in a separate table 150 for immediate or later use by a recruiter.

A next filter 160 may be used to infer management readiness of the candidates on the results list 70. This computation may take into account at least a relationship between one or more of the number of patents documents on which the candidate is listed, the inferred number of years of experience, the inferred employment stability, or other criteria deemed to be relevant and important for management candidates or known to one having ordinary skill in the art. The inferred management readiness with each name may optionally be recorded in a separate table 170 for immediate or later use by a recruiter.

A next filter 185 may be used to infer the depth of credentials of a candidate on the results list 70 by, for example, taking into account forward citations from one or more patent documents (e.g., acting as pseudo-peer review credentials) and may also, optionally, may take into account backward citations from one or more patent documents (e.g., inferring depth of research knowledge). The list of names with the inferred depth of credentials may optionally be recorded in a separate table 195 for immediate or later use by a recruiter.

Additional filters may be added into the system with the limitations being only practical when considering computer processing time, the depth of candidate analysis required by the recruiter and the total number of names (“n” names) that the recruiter elects to assess. Likewise, other filters known to one having ordinary skill in the art may be included in the system.

At any time during the assessment process as determined by the program parameters, or if allowed by the program by the recruiter, the recorded inferred and actual qualifications that have been recorded in separate tables can be combined into a single displayed list of names 180 for final analysis. This list 180 may be either a static presentation of candidates with their respective qualifications, or a list that may be sortable according to any particular filter. Optionally, one or more candidates may be selected from the list 180 and a resume dossier 205 can be created for each candidate selected from the list 180.

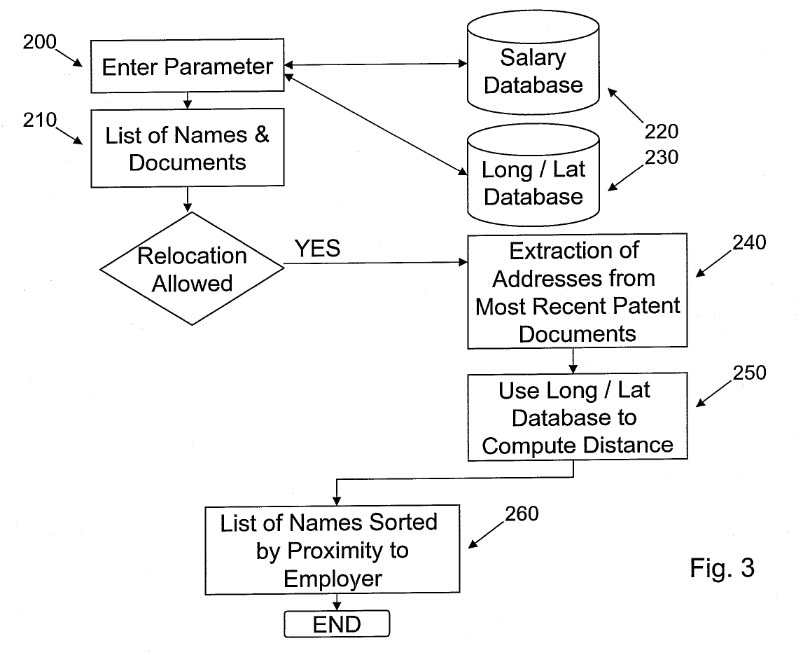

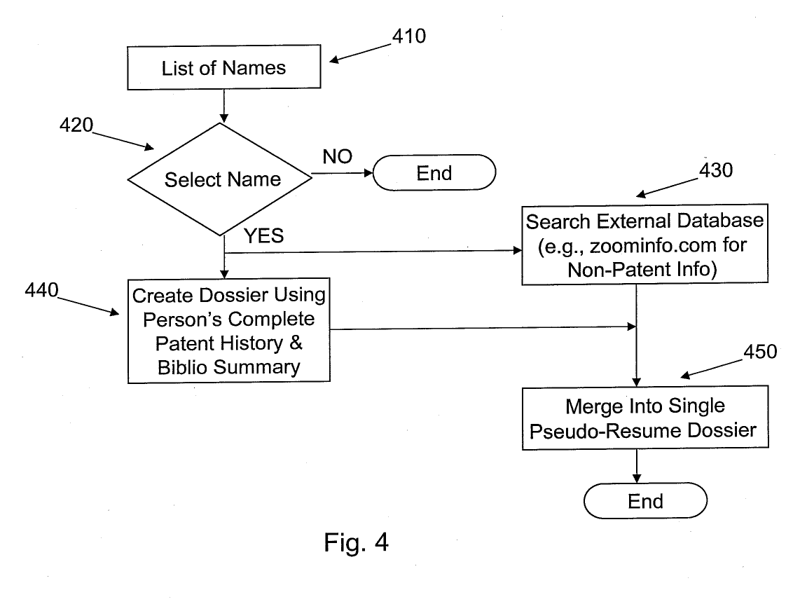

In personnel recruiting other qualifications may be considered by employers prior to presenting employment offers, for example, where the candidate is residing and whether relocation may be required. For instance, a location parameter may be added to exemplary embodiments. The flowchart of FIG. 3 shows one such embodiment.

FIG. 3. is a flow chart of an exemplary embodiment showing how additional databases can be added to the recruiting system. A salary database 220 can be used to help the recruiter determine the average pay scale for a particular job skill level in the region where the candidates reside and where the company is located. If a salary parameter is required by the recruiter, a salary level based on skills or other candidate qualifications can be entered as a parameter prior to starting the search 200, or may be entered at other points during the process.

Likewise, if the employer desires not to pay relocation expenses to a candidate, they could limit their search to candidates close to the hiring office. In this case, the employer's location can be entered into the system by means of a longitude/latitude database 230, or a zip code directory as a few non-limiting examples. When the list of names 210 is identified, a geographic location can be determined for each name on the list by extracting the “Applicant Address” (e.g. “Inventor Address” and/or “Assignee Address”) or “Attorney/Agent Address” data field 240 from the patent documents. A computation 250 comparing the candidate's location to the employer's location can identify the closest and most distant candidates 260. Although the above exemplary embodiments discuss not paying relocation expenses any means known to one having ordinary skill in the art to determine a candidate's and employer's location may be used.

Now generally referring to FIGS. 1-4, at least one exemplary embodiment of the present invention may provide a searcher the option of compiling a document that contains, for example, key information of each candidate, qualifications of the candidate relative to any set of rules applied to the search results and the pseudo-resume documents (e.g., patent literature). As shown in the exemplary flowchart of FIG. 4, this document may be a pseudo-resume dossier 450 that may be created by using a candidate's predominantly patent-related information 440 (although it may also contain, for example, bibliographic data) or, alternatively, may be created by using predominantly non-patent information 430 that may be acquired from another source (e.g., an external database). Additionally, both predominantly patent-related information 440 and non-patent information 430 may be merged into a single pseudo-resume dossier 450 for one or more candidates selected 420 from the list 410.

Again referring generally to FIG. 1-4, in one embodiment, a recruiter can generate a list of candidates, e.g., 60, 70, 180, 210, 260 and 410 based on: (a) the use of a job description as a semantic search query 10; (b) a database of patent literature; (c) a semantic database of pseudo-vectors 20 of the concepts expressed in the patent literature; (d) a set of one or more qualification filters (see, e.g., FIG. 3); (e) a set of one or more inference filters such as 80, 100, 120, 140, 160 and 185; and (f) a method of compiling and viewing the results list of candidates best meeting the job requirements (see FIGS. 3 & 4).

This embodiment is not intended to limit the database of pseudo-resume documents to patent literature (e.g., granted patents and published patent applications) or the semantic pseudo-vectors database 20 to expressing concepts contained in the patent literature. Also, many variations exemplary embodiments will generate acceptable lists of names of candidates even if additional databases are added, or if qualification filters and inference filters such as 80, 100, 120, 140, 160 and 180 are added or even if eliminated from the recruiting system. For example, a qualification filter may include limiting (either before or after the returning result set 30) the application of the search query to one or more assignees named in the patent literature so that the search may potentially identify the best candidate from a target company(ies). On the other hand, a “NOT” filter may be used to identify and/or exclude candidates from a particular company, for instance, to identify and/or exclude candidates that may have conflicts of interest such as when identifying a technical or otherwise qualified expert for patent litigation.

Likewise, any system known to one having ordinary skill in the art may be used. Scientific or legal documents including dissertations, journal articles authored by the candidates, news articles and press releases, court decisions, or other collections containing contributed or referenced works by experts in targeted fields may similarly be used. Other subject matter experts may include teachers, doctors, business or financial executives, or experts in more specialized fields of medicine or law. It is not the intention of this invention to limit the breadth or depth of industries, since nearly every industry employing subject matter experts has an occasional need to identify and recruit qualified employees.

An exemplary embodiment includes a computer system including one or more databases, at least one database containing bibliographic text of patent documents; a natural language search query represented in the form of a job description 10; a method of searching the database for patent documents that are responsive to the job description search query; and a results set 30 identifying one or more inventors, attorneys, agents, or examiners responsive to a job description query.

Still referring generally to FIGS. 1-4, another exemplary embodiment may include the system above, including a means to expand or narrow a results set by the addition of Boolean or keyword limiters. Also, another embodiment may include a means to sort a results set according to a geographic location of the inventors or assignees of each patent or published application (see, e.g., FIG. 3). Likewise, another embodiment may include a means to sort results according to comparisons to a salary database 220.

Yet another exemplary embodiment may include a system similar to that described above and may include a means to sort a results set 30 according to the number of patent publications relating to each inventor, attorney, agent or examiner. It may also include a means to sort a results set 30 according to one or more data fields (i.e. computer text fields) contained on the patent publication. Thus, a system may also include a means to sort a results set 30 based on the name of an applicant or assignee of a patent or published application. Alternatively, a system may include a means to sort a results set 30 based on the names of at least one listed inventor. Lastly, a system may include a means to sort a results set 30 by combining more than one text field.

In another exemplary embodiment a computer system may include at least one database, the at least one database containing bibliographic text of patent documents; a natural language search query represented in the form of a job description 10; a method of searching the database for patent documents that are responsive to the job description search query; and a results set that infers the skill set or qualifications of one or more inventors, attorneys, agents, or examiners (see, e.g., FIG. 2). Likewise, another embodiment may also include a means to identify persons known to have collaborated with the person named in the search results set.

In another exemplary embodiment a computer system may include at least one database, the at least one database containing bibliographic text of patent documents; a natural language search query represented in the form of a job description 10; a method of searching the database for patent documents that are responsive to the job description search query; and method of compiling a document containing qualifications of one or more inventors, attorneys, agents, or examiners (see, e.g., FIGS. 3 & 4).

In yet another exemplary embodiment a computer system may include at least one database, the at least one database containing bibliographic text of trademark documents; a natural language search query represented in the form of a job description 10; a method of searching the database for trademark documents that are responsive to the job description search query; and a results set 30 identifying attorneys or examiners responsive to a job description query.

At least one exemplary embodiment of the present invention discloses a system (or apparatus or device) and method of mining a database containing literature such as patents (e.g., granted patents and published patent applications) using a semantic search query 10 to identify a list of candidates 60 for recruiting by the searcher. Further, an embodiment may include a first database containing a large collection of homogeneous literature such as patent literature, and a second database 20 containing pseudo-vectors expressing the semantic concepts contained in the documents of the first database.

Still referring generally to FIGS. 1-4, in another exemplary embodiment, additional databases containing data collections unrelated to the first two databases such as 220 and 230, although not required, may be used by the researcher to narrow the results of a search query upon the first or second 20 databases. The search may begin by applying the full text of the description of a job opportunity as a semantic search query 10 upon a database of pseudo-vectors 20. Additionally, at least one exemplary embodiment of the present invention identifies the patent documents 30 most closely matching the job description 10.

In another exemplary embodiment of the present invention, the search results 30 may be displayed on a web browser or similar application as a list of patent publications most closely matching the concepts expressed in the job description 10. Thereafter, the names and other data related to the experts contained on the list of patent publications may be extracted from the first database 40. This list of names 60 includes the initial list of candidates qualified for the described job.

In another exemplary embodiment, additional filters such as required years of experience, or the distance between the candidate's place of residence and the hiring organization 250 may be added allowing a researcher to narrow the list of potential candidates 210. Likewise, any other filters known to one having skill in the art may be added to narrow the list of potential candidates 210.

Also, in another exemplary embodiment, a set of inferences such as 80, 100, 120, 140, 160 and 185 may be applied to the search results list 70 so that additional qualifications of the candidates can be extracted such as 90, 110, 130, 150,170 and 195. Inferred qualifications may include, but are not limited to, the candidates' knowledge inventory 100 as derived from patent classifications listed on the candidates' patents, job hops as derived from the number of applicants or assignees listed on all patents containing the candidates' names, or history of being a team player 140 as determined by the number of other associates listed on all of the patents containing the candidate's name.

The result of at least one exemplary embodiment may be a relevancy-ranked list of qualified candidates (e.g., 60, 70, 180, 210, 260 and/or 410) as determined by the semantic search results and the simultaneously or, alternatively, sequentially applied rules and inferred qualifications. In another exemplary embodiment, the final list of candidates can be sorted or, optionally, reorganized by the searcher based on one or more characteristics of the candidates. For example, of the candidates listed, the searcher can identify which ones are located closest to the hiring firm 260, which ones have more than a specified number of years of experience 80, or which ones have the fewest number of previous employers 120.

Further, at least one exemplary embodiment may identify the individual in a sequence before identifying that individual's specialty. Also, in at least one exemplary embodiment, the searcher may change the search profile parameters, and further may change the importance of any parameter as a means to reorganize the results to identify candidates based on management, hiring or economic dynamics.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A system for identifying subject matter experts, comprising:
at least one first database populated by at least one first data collection having a plurality of bibliographic text data;
at least one second database that is a semantic database populated by a plurality of pseudo-vectors for expressing a plurality of semantic concepts of the at least one first data collection; and
a search module having at least one search parameter, the search module operatively interfaced with the at least one first database and the at least one second database, whereby the search module is configured to perform on a semantic search query and configured to return at least one relevancy-ranked search result set having at least one candidate.

2. The system of claim 1, wherein the at least one first data collection is at least one patent literature data collection.

3. The system of claim 1, wherein the semantic search query is a textual description of a job opportunity.

4. The system of claim 1, wherein the at least one relevancy-ranked search result set is configured to be sortable.

5. The system of claim 1, further comprising:
at least one inference filter applied to the at least one relevancy-ranked search result set returned by the search module for extracting at least one qualification data for the at least one candidate.

6. The system of claim 5, wherein the at least one inference filter is at least one of a years of experience inference, a knowledge inventory inference, an employment stability inference, a team player characterization inference and a management readiness inference.

7. The system of claim 1, further comprising:
a salary database populated by a plurality of pay scale data responsive to a salary parameter of the search module for use in determining at least one pay scale data for the at least one candidate.

8. The system of claim 1, further comprising:
a location database populated by a plurality of location data responsive to a location parameter of the search module for use in determining at least one relative location data for the at least one candidate.

9. The system of claim 1, further comprising:
a display module configured to display at least one relevancy-ranked search result set.

10. The system of claim 9, wherein the display module is a web browser.

11. A method of identifying subject matter experts, comprising:
submitting a search query to at least one semantic database populated by a plurality of pseudo-vectors expressing a plurality of concepts from at least one data collection populated by a plurality of data;
applying the search query to the at least one semantic database; and
returning at least one result set from the at least one data collection, the result set having at least one subject matter expert candidate data in relevancy-ranked order.

12. The method of claim 11, further comprising:
displaying the at least one result set via a web browser.

13. The method of claim 11, further comprising:
extracting at least one data in reference to the at least one subject matter expert candidate from the at least one result set.

14. The method of claim 11, further comprising:
extracting at least one name data from the at least one result set; and
listing the at least one name data for the at least one subject matter expert candidate data in relevancy-ranked order.

15. The method of claim 11, further comprising:
applying at least one inference filter to the at least one result set, wherein the at least one inference filter is at least one of a years of experience inference, a knowledge inventory inference, an employment stability inference, a team player characterization inference and a management readiness inference.

16. The method of claim 11, wherein the search query is a textual description of a job opportunity.

17. The method of claim 11, wherein the at least one subject matter expert candidate is at least one patent professional.

18. The method of claim 11, wherein the at least one data collection is of technical literature.

19. The method of claim 11, further comprising:
compiling at least one document having more than one qualification data of the at least one subject matter expert candidate.

20. The method of claim 11, further comprising:
accessing a salary database populated by a plurality of pay scale data; and
returning at least one pay scale data.

21. The method of claim 11, further comprising:
accessing a location database populated by a plurality of location data; and
returning at least one location data.

22. The method of claim 13, further comprising:
recording the at least one data in at least one table for use by a user.

23. A method for identifying patent professionals, comprising:
submitting a textual description of a job opportunity as a search query to at least one semantic database having a plurality of pseudo-vectors expressing a plurality of semantic concepts from at least one patent literature database populated by a plurality of patent literature data;
applying the search query to the at least one semantic database;
returning at least one result set having at least one patent literature data in relevancy-ranked order;
extracting at least one name data from the at least one patent literature data;
listing the at least one name data in relevancy-ranked order, whereby the at least one name data is checked for duplicates and merged
applying at least one inference filter to the at least one result set, wherein the at least one inference filter is at least one of a years of experience inference, a knowledge inventory inference, an employment stability inference, a team player characterization inference and a management readiness inference;
extracting at least one other data responsive to the at least one filter from the at least one patent literature database;
recording the at least one other data to at least one table;
displaying a list of the at least one name data, wherein the list is configured to be sortable; and
compiling a document containing a plurality of qualification data.
